(19) United States
(12) Patent Application Publication
(10) Pub. No.: US 2017/0144196 A1
(43) Pub. Date: May 25, 2017

(54) SEPARATOR, IN PARTICULAR BALLISTIC SEPARATOR

(71) Applicant: Doppstadt Familienholding GmbH, Velbert (DE)

(72) Inventors: Hendrik SCHULZE BUXLOH, Hattingen (DE); Benjamin KREVET, Mettmann (DE)

(73) Assignee: Doppstadt Familienholding GmbH, Velbert (DE)

(21) Appl. No.: 15/319,412

(22) PCT Filed: Jun. 16, 2015
(86) PCT No.: PCT/EP2015/063482

§ 371 Date: Dec. 16, 2016

(30) Foreign Application Priority Data
Jun. 17, 2014 (DE) 20 2014 004 852.5
Jul. 2, 2014 (DE) 20 2014 005 409.6

(51) Int. Cl. B07B 13/11

(52) U.S. Cl. CPC B07B 13/113

(57) ABSTRACT

The invention relates to a ballistic separator for separating mixed waste materials, wherein at least two adjacent paddles, strips, or a sheet metal plate are arranged in a frame so as to be movable and form a base, said base being arranged in the frame with a gradient with respect to the mounting surface of the separator, and the base being mounted on at least one side of a shaft on a paddle holder so that the base can. be set in rotation, a drive unit for generating the rotational movement being provided and driving at least one shaft. The shaft is designed as an eccentrically mounted outer tube, eccentric disks being fastened or immobilized in the eccentric tube on an inner shaft, a bearing being provided between the eccentric disk and the eccentric tube and the paddle holder being mounted on the eccentric tube.

### BACKGROUND OF THE INVENTION

The invention relates to a separator, in particular a ballistic separator.

Separators of this kind are sufficiently known in the state of the art. Ballistic separators serve for classifying mixed material fractions with reference to size, geometric properties and weight, and generating different output fractions. This makes the subsequent automatic or manual sorting easier, and ensures recovery of single-origin material fractions, Because of its separation principle a ballistic separator is particularly well suited for solving organic substances from mixed waste materials such as household and municipal waste. Accordingly ballistic separators regularly serve for separating a two-dimensional or three-dimensional fraction of household and industrial waste.

As a rule the known separators consist of strips, the so-called paddles, arranged one beside the other and continuously executing a circular movement. The paddles form a base arranged with a gradient at or in a machine frame. The material to be separated is put in the center of the base. The paddles transmit an impulse to the material to be separated triggering an individual flight path of the single components of the material to be separated. Two-dimensional and light particles receive an impulse triggering a forward-directed path curve. They “climb” upwards on the screening surface. Three-dimensional and heavy particles execute a downwards-directed flight path; they “roll” downward. Additionally a ballistic separator separates a third fraction. The paddles are provided with holes so that the so-called zero component and particles with small grain size fall downwards. Because of the permanent impulse transmission to the material adhering dirt particles are solved and fall through the perforated strips. The paddles are arranged with an offset rotation angle. There are also solutions where the base consists of a sheet metal instead of single paddles. The circular movement of the sheet metal and the paddles is the same.

In the state of the art it is also known to generate the circular movement of the paddles arranged with an offset rotation angle either by a sort of crankshaft or eccentric discs slid on a straight shaft. In the last-mentioned solution every single paddle has two eccentric discs. Each eccentric disc is mounted separately. Also when using a crankshaft each crankpin has to be mounted in order to ensure the relative speed between the crankshaft and the paddle holder. It has been proven that the production costs for separators of this kind are very high. Because of the above described “zero component” falling through the bearing is exposed additionally to a high degree of soiling, The consequences are high wear as well as long standstill and repair times.

Therefore it is a problem of the invention to suggest a separator, in particular a ballistic separator, not having at least one of the above-described disadvantages of the state of the art.

### BRIEF SUMMARY OF THE INVENTION

The invention relates to the above-described state of the art, and in order to solve the problem suggests a separator, in particular a ballistic separator for separating mixed waste materials wherein at least two adjacent paddles or strips or at least a sheet metal are arranged movably in a frame, and thus form a base wherein the base is arranged with a gradient with respect to the mounting surface of the separator in the frame, and the base is supported at least on one side at or on a shaft at at least one paddle holder such that the frame can be set in a rotational movement, wherein a driving unit is provided for generating the rotational movement that drives the at least one shaft, and the separator is characterized in that the shaft is provided as an outer tube mounted eccentrically or as eccentric tube, in the eccentric tube eccentric discs are arranged or fixed on an inner shaft, between eccentric disc and eccentric tube a bearing is provided, and the paddle holder is arranged at the eccentric tube. By providing the bearing in the eccentric tube the eccentric tube is contaminated only on the outside so that no contamination or dirt can get to the sensitive bearing points. The at least one shaft is mounted at the frame and is driven by the driving unit, however such that dirt cannot get there, either, or the degree of soiling is very low. This, of course, reduces considerably the wear and the downtime. The separator can remain clearly longer in the operation according to its purpose than the separators according to the state of the art. The solution according to the invention makes it also possible to increase the overall width of the base as, in contrast to the use of a crankshaft, the production effort is reduced as only eccentric discs are fastened to a shaft, and then this shaft is surrounded by the eccentric tube. Of course, this makes possible an arrangement of a suitable number of adjacent paddles for forming the base or a screening surface.

An advantageous development of the separator according to the invention is characterized in that at least two adjacent eccentric tubes are provided the inner shafts thereof having an offset rotation angle. This offset rotation angle is necessary for a mutually oscillating movement of the base or the paddles forming the base. Advantageously, of course, the paddles are fixed or mounted on both sides at the eccentric tube for a more even load. However, according to the invention, it is sufficient to provide two adjacent eccentric tubes,

An advantageous development of the invention is characterized in that the offset rotation angle is between 120 and 180 degrees. The offset rotation angle is preferably chosen such that if, for example, the base is formed by two or four paddles, the offset angle is 180°, while the offset angle with an arrangement of three or six paddles is 120°.

As already mentioned the separator according to the invention is also characterized in that four eccentric tubes are provided, wherein two eccentric tubes are provided as first pair of eccentric tubes at the top end of the base (seen in mounting direction), and two more eccentric tubes as second pair of eccentric tubes at the bottom of the base. This serves for the favorable mount and, in particular, also a more even load and perfection of the oscillation behavior of the paddles. The configuration described above also has the effect that no or only a few ruptures or fractures occur in the paddles by uncontrolled oscillations or rotational movements.

According to the invention it is possible that the base is formed by 2, 3, 4, 6, 8, 9, or 10 adjacent paddles. Depending on the chosen width for the base a suitable number of paddles is arranged one beside the other. It is clear that each time when the number of paddles can be divided by two preferably an offset angle of 180° is chosen, while each time when the number of paddles can be divided by three, preferably an offset angle of 120° is chosen. Accordingly it is clear that the number of adjacent paddles can be clearly larger that it has been possible in the state of the art so far.

Furthermore it is provided according to the invention that the paddles are arranged or fixed at paddle holders. The paddle holder is the connection between shaft and screening paddle. The offset rotation angle has to be kept exactly across the shafts as otherwise, as already mentioned, tensions occur along the paddles that lead to the paddles to be fractured when they are in use during long operating hours. Therefore a buffer is provided in the paddle holders compensating small production tolerances. It is advantageous when the paddle holders are formed by leaf springs elements. Besides a favorable wear behavior this also achieves a perfection of the oscillation behavior of the base. Also the screening performance is perfected.

Furthermore it is provided according to the invention that the leaf spring elements of the paddle holders are mounted such that they only allow clearance in longitudinal direction. This is necessary in order to prevent the paddles from touching each other at their flanks. This would lead to wear or damage of the paddles. However, clearance in longitudinal direction is necessary for compensating the already-mentioned tensions along the paddles. The invention provides at least one paddle holder for each paddle.

For generating the upward and downward movement or the circular movement of the paddles a drive unit is provided. The drive unit is formed by a motor and transmission elements for a rotary movement. The drive unit takes care that the eccentric tubes, in particular when the offset angle of the paddle pairs is 180°, are driven synchronously at the top as well as at the bottom part of the machine or the base.

It has been proven here to be advantageous when the motor is arranged at the frame between the eccentric shafts outside and centered.

Furthermore it has been found according to the invention that as transmission elements toothed belts with suitably formed toothed belt discs are provided to set the eccentric tubes in a rotary movement.

Adjacent eccentric tubes are driven by synchronizing belts in order to reach the desired synchronization of the pairs of paddles.

In order to prevent the eccentric tube or the bearing in the eccentric tube from contamination it is provided according to the invention that the eccentric tube is covered by a lid on its front side. In addition to preventing the dirt from getting inside over the entire width of the screen surface or the base, dirt is also prevented from getting in the eccentric tube on the front side.

### BRIEF DESCRIPTION OF THE DRAWINGS

In the following the invention is described further by means of examples. In the drawings:

FIG. 1A a side view of an embodiment of a separator according to the invention with 6 paddles,

FIG. 1B a view of a separator according to the invention along the cutting line A-A of FIG. 1A,

FIG. 2A a front view of the separator according to the invention according to FIG. 1A,

FIG. 2B a view of the separator according to the invention along the cutting line B-B of FIG. 2A, and

FIG. 3 a top view of the separator according to the invention in the embodiment according to FIGS. 1A and 1B.

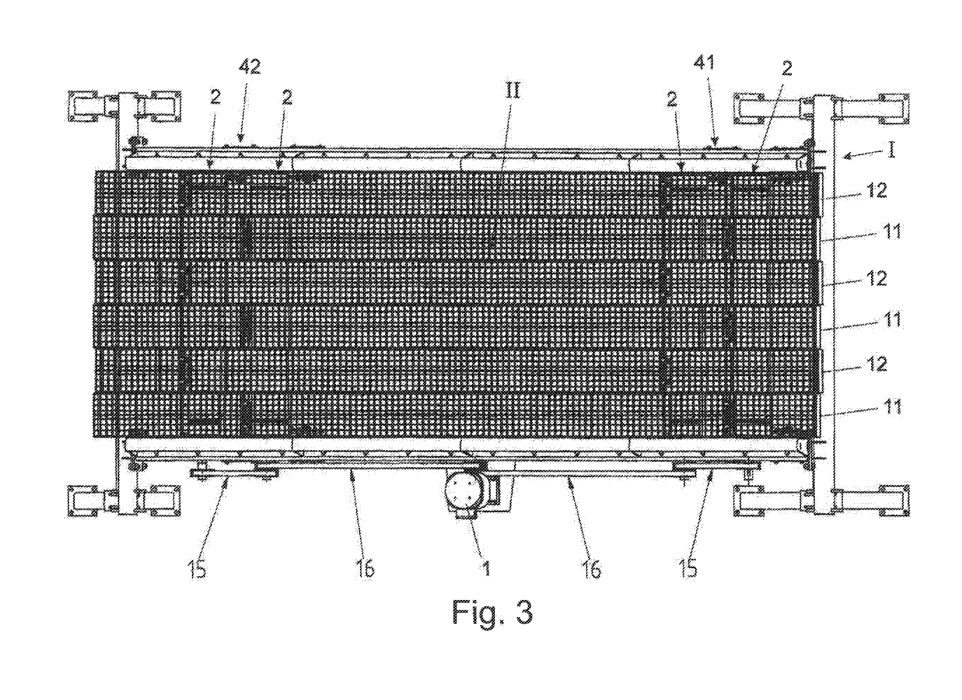

In the following the invention will be described by means of an embodiment. The single figures show different views or sections of an embodiment of the separator according to the invention, In all figures consequently identical reference numbers are used for analogous characteristics so that the invention is shown complexly.

### DETAILED DESCRIPTION OF THE INVENTION

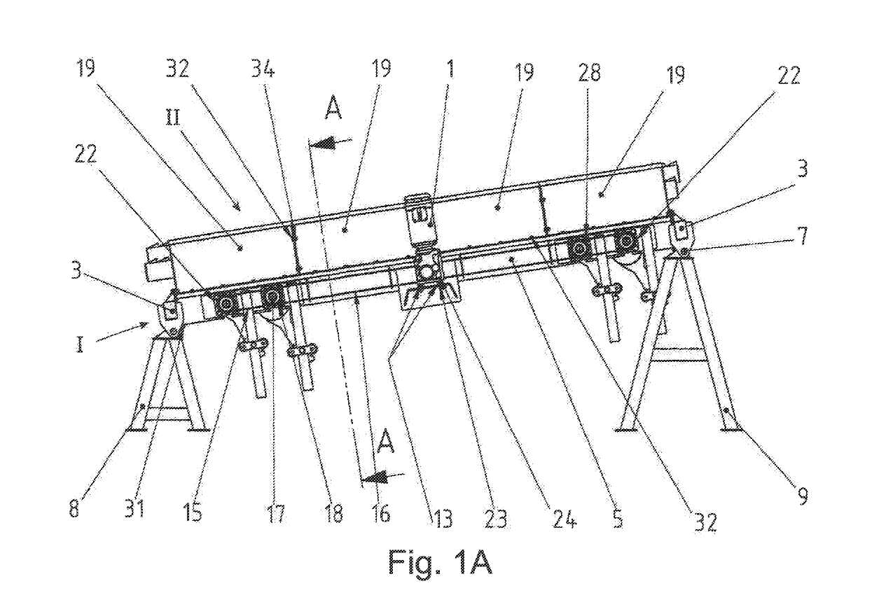

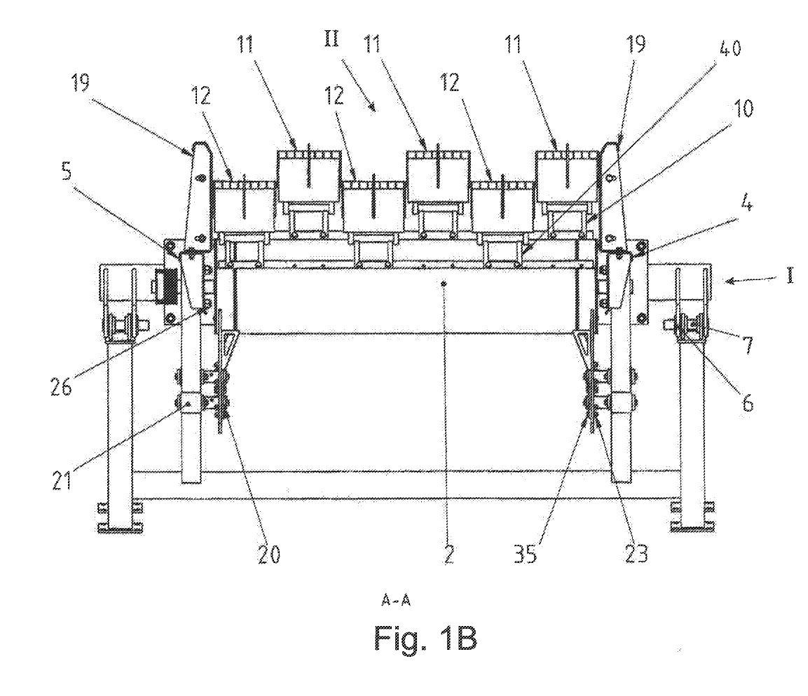

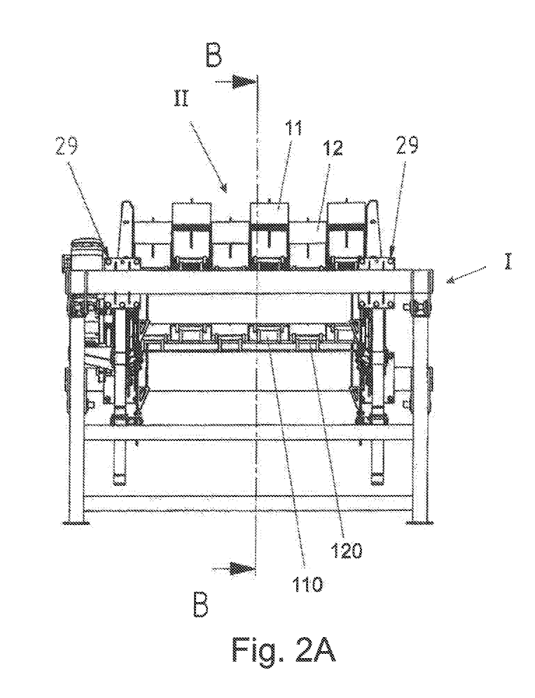

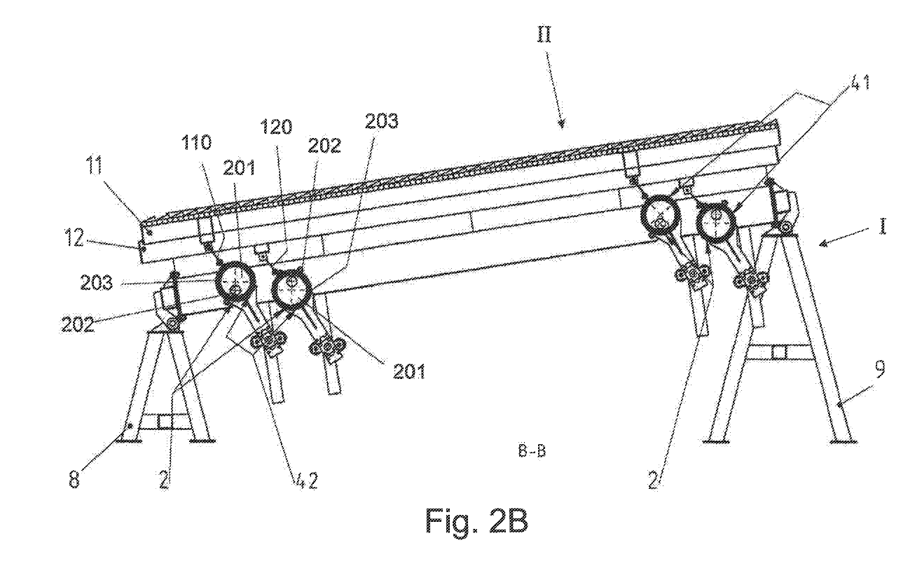

FIG. 1A shows a side view of the separator according to the invention. The separator consists of a frame I and the base II. The base II is mounted on shafts formed by eccentric tubes 2. These are shown very clearly in FIG. 28. In the eccentric tube 2 eccentric tube discs 201 are attached to or fixed on an inner shaft 202. Between eccentric disc 201 and eccentric tube 2 a bearing 203 is provided. In the shown embodiment four eccentric tubes altogether are provided (see FIG. 2B). Two eccentric tubes 2 are provided as a first pair of eccentric tubes 41 at the top end of the base I, seen in installation direction, and two other eccentric tubes 2 as a second pair of eccentric tubes 42 at the bottom end of the base I. Paddle holders 110, 120 are arranged at the eccentric tube 2. The base II is formed by 6 paddles 11, 12 in the shown embodiment. This configuration is by no means restricting, but shows only one possible embodiment of the separator according to the invention. As already mentioned above in the description it is possible to use two, three, six, eight, nine, or ten paddles 11, 12. The frame I is attached to or put up at a short elevation 8 and a long elevation 9 such that the base II, with respect to the installation surface, is arranged at an increasing angle, seen from left to right. Furthermore, the frame I is formed by a front frame 3 and frame sheet metals 4, 5. A sidewall 19 completes the frame on the side. At the elevations 8, 9 the frame I is defined by means of bolts 7 fixed on the side by discs 6. A not in detail described guide unit, at least consisting of a not in detail described rod, a roller holder 21 and a turn piece 20 is provided for a lateral and vertical guide of the eccentric tubes 2. It is arranged left and right, respectively (see section A-A in FIG. 1B) besides the eccentric tubes 2. The base II or the single paddles 11, 12 are connected via the paddle holders 110, 120 with the eccentric tubes 2. They are preferably formed by leaf spring elements 10, 40. For each paddle 11, 12 at least one paddle holder 110, 120 at each eccentric tube 2 is provided. A drive unit, consisting of a drive motor 1 and transmission elements completes the separator according to the invention. The drive motor 1 produces a rotary movement that is transmitted via the transmission elements to the eccentric tubes 2. As transmission elements toothed belt discs 18 and toothed belts 15, 16 are provided. Thus the rotary movement is transmitted synchronously to the eccentric tubes 2. The eccentric arrangement of the inner shaft 202 and provision of the eccentric tube discs 201 at the eccentric tube 2 generates an oscillating rotary movement of the paddles 11, 12. The consequence is the already described effect that an impulse is transmitted to the material to be separated leading to a separation of the single particles. Because of the covered arrangement of the inner shaft 202 and the eccentric discs 201 in the eccentric tube 2 dirt falling through cannot affect the bearing 203. Additionally, the eccentric tubes 2 are sealed by lids on the front side so that intrusion of dirt particles is almost impossible. Other reference numbers in the drawings refer to different machine elements that are of no relevance for the invention. These are nuts 23, 26, 31, 34, screws 24, 28, 29, 32, 35, 37, and discs 25, 27, 30, 33, 36. Flange bearings are referred to by 22, a taper sleeve by 14 or 17, and a distance plate by 13.

The invention has been described before by means of an example. The claims filed now and to be filed later on along with the application are attempted formulations without prejudice for obtaining a broader protection.

The references in the sub-claims relate to the further design of the matter of the main claim through the characteristics of the respective sub-claim. These are, however, not to be understood as a waiver for obtaining independent subjective protection for the characteristics of the respective sub-claims.

Characteristics only disclosed in the description so far may now, in the course of proceedings, be claimed as being of inventive relevance, for example to distinguish from the state of the in the claims.

1. Separator, in particular ballistic separator for separating mixed waste materials, wherein at least two adjacent paddles or strips, or at least a sheet metal plate are arranged in a frame movably and thus form a base, wherein the base is arranged in the frame with a gradient with respect to the mounting surface of the separator in the frame and the base is mounted at least on one side at or on a shaft on a paddle holder in such a way that the base can be set in rotation, wherein a drive unit for generating the rotational movement is provided driving the at least one shaft, wherein the shaft is provided as an eccentrically mounted outer tube, in the eccentric tube eccentric discs are fastened or fixed on an inner shaft, between eccentric disc and eccentric tube a bearing is provided, and the paddle holder is arranged at the eccentric tube.

2. Separator according to claim 1, wherein seen from the side at least two adjacent eccentric tubes are provided the inner shafts thereof having an offset rotation angle.

3. Separator according to claim 2, wherein the offset rotation angle is between 120 and 180 degrees.

4. Separator according to claim 1, wherein four eccentric tubes are provided, wherein two eccentric tubes are provided as first pair of eccentric tubes at the top end of the base seen in mounting direction, and two other eccentric tubes as second pair of eccentric tubes are provided at the bottom end of the base.

5. Separator according to claim 1, wherein, the base is formed by 2, 3, 4, 6, 8, 9, or 10 adjacent paddles.

6. Separator according to claim 1, wherein the paddle holders are formed by leaf spring elements.

7. Separator according to claim 6, wherein the leaf spring elements of the paddle holders are mounted such that they only allow clearance in longitudinal direction.

8. Separator according to claim 6, wherein for each paddle a paddle holder is provided.

9. Separator according to claim 1, wherein the drive unit is formed by a motor and transmission elements for a rotary movement.

10. Separator according to claim 1, wherein the motor is arranged at the frame between the eccentric shafts outside and centered.

11. Separator according to claim 1, as transmission elements toothed belts with suitably designed toothed belt discs are provided to set the eccentric tubes in a rotary motion.

12. Separator according to claim 1, wherein adjacent eccentric tubes are driven by synchronization belts.

13. Separator according to claim 1, wherein the eccentric tube is sealed by lids on the front side.
